(19) United States
(12) Patent Application Publication
(10) Pub. No.: US 2017/0026707 A1
(43) Pub. Date: Jan. 26, 2017

(54) ELECTRONIC DEVICE FOR PROVIDING INFORMATION ASSOCIATED WITH BROADCAST CONTENT AND METHOD THEREOF

(71) Applicant: SAMSUNG ELECTRONICS CO., LTD., Suwon-si (KR)

(72) Inventors: Ji-won YOO, Seongnam-si (KR); Kyung-su PARK, Seoul (KR); Yong-wook SHIN, Hwaseong-si (KR); Kye-hyeon KIM, Suwon-si (KR); Dong-hyun CHOI, Suwon-si (KR)

(73) Assignee: SAMSUNG ELECTRONICS CO., LTD., Suwon-si (KR)

(21) Appl. No.: 15/175,604

(22) Filed: Jun. 7, 2016

(30) Foreign Application Priority Data
Jul. 22, 2015 (KR) 10-2015-0103871

(51) Int. Cl. H04N 21/482; H04N 21/84; H04N 21/61; G06F 17/30

(52) U.S. Cl. CPC H04N 21/4828; G06F 17/30867; G06F 17/30528; G06F 17/30554; H04N 21/84; H04N 21/6125

(57) ABSTRACT

An electronic device for providing information associated with broadcast content and a method thereof are provided. The electronic device includes a tuner configured to receive the broadcast content, and a controller configured to extract an object from the broadcast content, determine one or more keywords identifying the object, select keywords for generating a search query from the one or more keywords, combine the selected keywords to generate the search query, and provide a user with information of a search result using the search query.

### CROSS-REFERENCE TO RELATED APPLICATION

This application claims priority from Korean Patent Application No. 10-2015-0103871, filed on Jul. 22, 2015, in the Korean Intellectual Property Office, the disclosure of which is incorporated herein by reference in its entirety.

### BACKGROUND

1. Field

Apparatuses and methods consistent with exemplary embodiments relate to an electronic device for providing information associated with broadcast content and a method thereof, and more particularly, to an electronic device for providing information associated with broadcast content by using search queries generated by analyzing the broadcast content, and a method thereof.

2. Description of the Related Art

A display device displays an image that a user may view. The user may watch broadcast content through the display device. The display device displays thereon broadcast content selected by the user from broadcast content transmitted as broadcast signals from a broadcast station. Recently, there has been a global change in broadcasting, from analog broadcasting to digital broadcasting.

Digital broadcasting indicates transmission of digital images and sound signals. Compared to analog broadcasting, digital broadcasting is resilient to external noise, thus resulting in reduced data loss, errors may be easily corrected, and a resolution and a definition are high. Also, digital broadcasting may provide an interactive service, unlike in the case of analog broadcasting.

In addition, smart TVs that, besides having a digital broadcasting function, provide various types of content, have been recently supplied. Thus, there is a necessity for research to be conducted into provision of broadcast content and diverse viewing environments to users who watch the broadcast content.

### SUMMARY

Exemplary embodiments may address at least the above problems and/or disadvantages and other disadvantages not described above. Also, the exemplary embodiments are not required to overcome the disadvantages described above, and may not overcome any of the problems described above.

Exemplary embodiments provide methods and apparatuses for an electronic device for providing information associated with broadcast content, and a method thereof.

According to an aspect of an exemplary embodiment, there is provided an electronic device for providing information associated with broadcast content, the electronic device including a tuner configured to receive the broadcast content, and a controller configured to extract an object from the broadcast content, determine one or more keywords identifying the object, select keywords for generating a search query from the one or more keywords, combine the selected keywords to generate the search query, and provide a user with information of a search result using the search query.

The controller may be further configured to extract the object from at least one among an image, a sound effect, a subtitle, and additional information included in the broadcast content by analyzing at least one among a person, a thing, and a situation included in the broadcast content.

The controller may be further configured to determine, as the one or more keywords, at least one among a name, an abbreviated name, a nickname, and a symbol identifying the object.

The electronic device may further include a communication interface, and the controller may be further configured to control the communication interface to transmit, to an external server, a request for information of keyword selection criteria including a use frequency, and select the keywords for generating the search query from the one or more keywords, based on the information of the keyword selection criteria, the information being received from the external server.

The controller may be further configured to select the keywords for generating the search query from the one or more keywords, based on user setting information.

The controller may be further configured to combine the selected keywords in an order of arranging the keywords, to generate the search query.

The electronic device may further include a communication interface, and the controller may be further configured to control the communication interface to transmit the search query to the external server, and receive, from the external server via the communication interface, the information of the search result using the search query.

The electronic device may further include a display, and the controller may be further configured to control the display to display the information of the search result.

The electronic device may further include a display, and the controller may be further configured to divide the display into portions, control the display to display the broadcast content on one among the portions, and control the display to display the information of the search result on another one among the portions.

The controller may be further configured to transmit the information of the search result to a preset display device, and control the preset display device to display the information of the search result.

The controller may be further configured to, in response to search queries being generated, determine a search query among the search queries according to a search result based on each of the search queries, and provide the user with information of a search result using the determined search query.

The controller may be further configured to analyze the broadcast content received at a point in time, in response to a user selection input for analyzing the broadcast content.

According to an aspect of another exemplary embodiment, there is provided a method of providing information associated with broadcast content, the method including receiving, by a tuner, the broadcast content, extracting an object from the broadcast content, determining one or more keywords identifying the object, selecting keywords for generating a search query from the one or more keywords, combining the selected keywords to generate the search query, and providing a user with information of a search result using the search query.

The extracting may include extracting the object from at least one among an image, a sound effect, a subtitle, and additional information included in the broadcast content by analyzing at least one among a person, a thing, and a situation included in the broadcast content.

The determining may include determining, as the one or more keywords, at least one among a name, an abbreviated name, a nickname, and a symbol identifying the object.

The selecting may include transmitting, to an external server, a request for information of keyword selection criteria including a use frequency, and selecting the keywords for generating the search query from the one or more keywords, based on the information of the keyword selection criteria, the information being received from the external server.

The selecting may include selecting the keywords for generating the search query from the one or more keywords, based on user setting information.

The combining may include combining the selected keywords in an order of arranging the keywords, to generate the search query.

The providing may include transmitting the search query to the external server, and receiving, from the external server, the information of the search result using the search query.

The providing may include displaying the information of the search result.

The providing may include dividing a display into portions, displaying the broadcast content on one among the portions, and displaying the information of the search result on another one among the portions.

The providing may include transmitting the information of the search result to a preset display device, and controlling the preset display device to display the information of the search result.

The providing may include, in response to search queries being generated, determining a search query among the search queries according to a search result based on each of the search queries, and providing the user with information of a search result using the determined search query.

The extracting may include analyzing the broadcast content received at a point in time, in response to a user selection input for analyzing the broadcast content.

### BRIEF DESCRIPTION OF THE DRAWINGS

The above and/or other aspects will be more apparent by describing exemplary embodiments with reference to the accompanying drawings, in which:

FIGS. 1A and 1B are schematic diagrams of an electronic device according to an exemplary embodiment;

FIG. 2 is a diagram of a system for providing information associated with broadcast content, according to an exemplary embodiment;

FIGS. 3 and 4 are block diagrams of an electronic device according to an exemplary embodiment;

FIG. 5 is a flowchart of a method of providing information associated with broadcast content, according to an exemplary embodiment;

FIG. 6 is a diagram of an example of analyzing broadcast content according to an exemplary embodiment;

FIG. 7 is a diagram of an example of extracting a keyword that identifies an object, according to an exemplary embodiment;

FIG. 8 is a diagram of an example of selecting a keyword for generating a search query, according to an exemplary embodiment;

FIG. 9 is a diagram of an example of information about keyword selection criteria according to an exemplary embodiment;

FIG. 10 is a diagram of an example of obtaining information about keyword selection criteria according to an exemplary embodiment;

FIG. 11 is a diagram of an example of generating a search query according to an exemplary embodiment;

FIG. 12 is a flowchart of an example of providing, via an external server, information about a search result using a search query, according to an exemplary embodiment;

FIGS. 13A, 13B, and 13C are diagrams of an example of providing, via a server, information about a search result using a search query, according to an exemplary embodiment;

FIG. 14 is a flowchart of an example of displaying information about a search result on another display device, according to an exemplary embodiment; and

FIG. 15 is a diagram of an example of displaying information about a search result on another display device, according to an exemplary embodiment.

### DETAILED DESCRIPTION

Exemplary embodiments are described in greater detail below with reference to the accompanying drawings.

In the following description, like drawing reference numerals are used for like elements, even in different drawings. The matters defined in the description, such as detailed construction and elements, are provided to assist in a comprehensive understanding of the exemplary embodiments. However, it is apparent that the exemplary embodiments can be practiced without those specifically defined matters. Also, well-known functions or constructions may not be described in detail because they would obscure the description with unnecessary detail.

It will be understood that the terms “comprises” and/or “comprising” used herein specify the presence of stated features or components, but do not preclude the presence or addition of one or more other features or components. In addition, the terms such as “unit,” “-er (-or),” and “module” described in the specification refer to an element for performing at least one function or operation, and may be implemented in hardware, software, or the combination of hardware and software.

While such terms as “first”, “second”, etc., may be used to describe various components, such components may not be limited to the above terms. The above terms are used only to distinguish one component from another.

An electronic device described herein may include an analog television (TV), a digital TV, a 3-dimensional (3D) TV, a smart TV, a light emitting diode (LED) TV, an organic light-emitting diode (OLED) TV, a plasma TV, a monitor, or the like. Also, the electronic device may be a desktop computer, a mobile phone, a smart phone, a tablet PC, a laptop, a digital broadcast terminal, a personal digital assistant (PDA), a portable multimedia player (PMP), a navigation device, or the like.

Throughout the specification, it will be understood that when an element or layer is “connected to” another element or layer, the element or layer can be “directly connected to” another element or can be “electrically connected” thereto with an intervening element or layer therebetween. When a portion “includes” an element, another element may be further included, rather than excluding the existence of the other element, unless otherwise described.

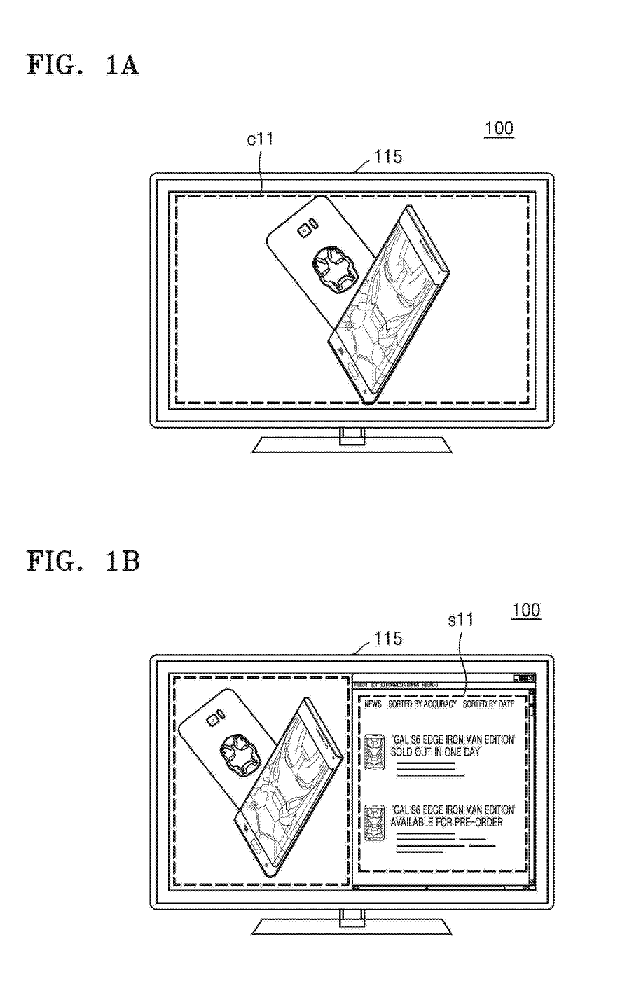

FIGS. 1A and 1B are schematic diagrams of an electronic device 100 according to an exemplary embodiment.

The electronic device 100 may provide a user with information associated with broadcast content. For example, while watching TV, the user may receive information associated with broadcast content that is being broadcasted, and the information may be, for example, search results from web portals. In this case, the electronic device 100 may generate a search query for appropriately providing the information associated with the broadcast content by analyzing the broadcast content.

FIG. 1A shows an example of displaying, by the electronic device 100, broadcast content c11 on a display 115. FIG. lb shows an example of displaying a search result s11 on the display 115, and the search result s11 is obtained from a web portal as information resulting from a search associated with the broadcast content c11.

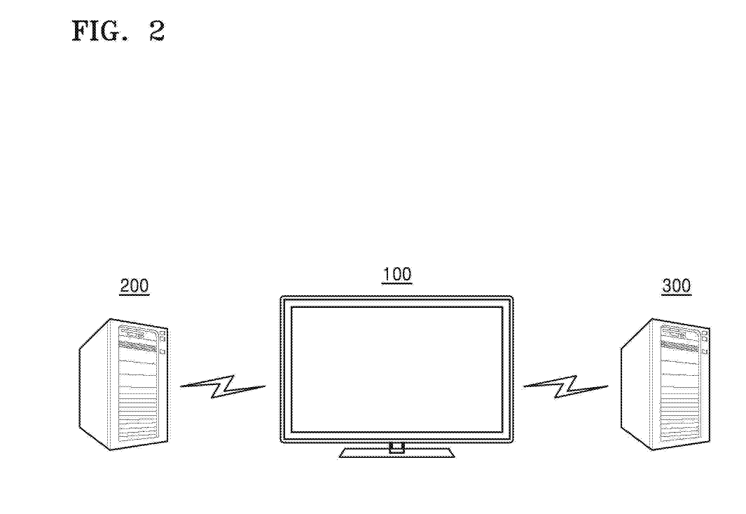

FIG. 2 is a diagram of a system for providing information associated with broadcast content, according to an exemplary embodiment.

Referring to FIG. 2, the system may include the electronic device 100, a first server 200, and a second server 300 that may communicate with each other via a network. Also, according to an exemplary embodiment, the system may include the electronic device 100 and the second server 300 that may communicate with each other via a network.

The network may be a communications network. The communications network may include at least one among a computer network, the Internet, the Internet of things, and a telephone network.

In the system of FIG. 2, the electronic device 100 may be embodied as an analog TV, a digital TV, a 3D TV, a smart TV, an LED TV, an OLED TV, a plasma TV, a monitor, or the like, but is not limited thereto.

The electronic device 100 may extract at least one object by analyzing the broadcast content and may extract at least one keyword that identifies the at least one object. Also, the electronic device 100 may select keywords for generating a search query from the at least one keyword. In addition, the electronic device 100 may generate a search query by combining the selected keywords. The electronic device 100 may transmit the search query to the second server 300 that provides a search service and may receive information about a search result using the search query from the second server 300.

According to another embodiment, the system may further include a set-top box or an IP set-top box connected to the electronic device 100. The set-top box or the IP set-top box is a terminal that includes a communication unit and a processor and provides a multimedia communication service via an external network.

According to an exemplary embodiment, the first server 200, the set-top box, or the IP set-top box that is connected to the electronic device 100 may extract at least one object by analyzing the broadcast content displayed on the electronic device 100 and may extract at least one keyword that identifies the at least one object. Also, the set-top box, the IP set-top box, or the first server 200 may select a keyword for generating a search query from the at least one keyword. Also, the set-top box, the IP set-top box, or the first server 200 may generate the search query by combining the selected keyword. Also, the set-top box, the IP set-top box, or the first server 200 may transmit the search query to the second server 300 that provides the search service and may receive, from the second server 300, the information about the search result using the search query.

As another example, the set-top box, the IP set-top box, or the first server 200 may transmit the generated search query to the electronic device 100, or the electronic device 100 may transmit the search query to the second server 300 that provides the search service. The electronic device 100 may receive the information about the search result using the search query from the second server 300.

The electronic device 100 is able to perform multitasking that concurrently performs various tasks. The electronic device 100 may perform multiple tasks concurrently, execute windows on a display 115, and display a task performance result in each window.

According to an exemplary embodiment, the electronic device 100 may receive the display content via a tuner 135 and may display the received broadcast content on a portion of the display 115 and may receive information about the search result that is obtained from a web portal via the communication unit 150 and may display the received information about the search result on another portion of the display 115 (refer to FIG. 1b).

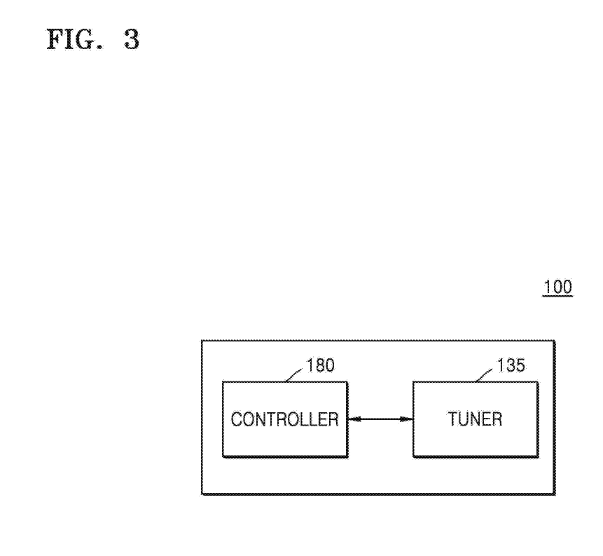

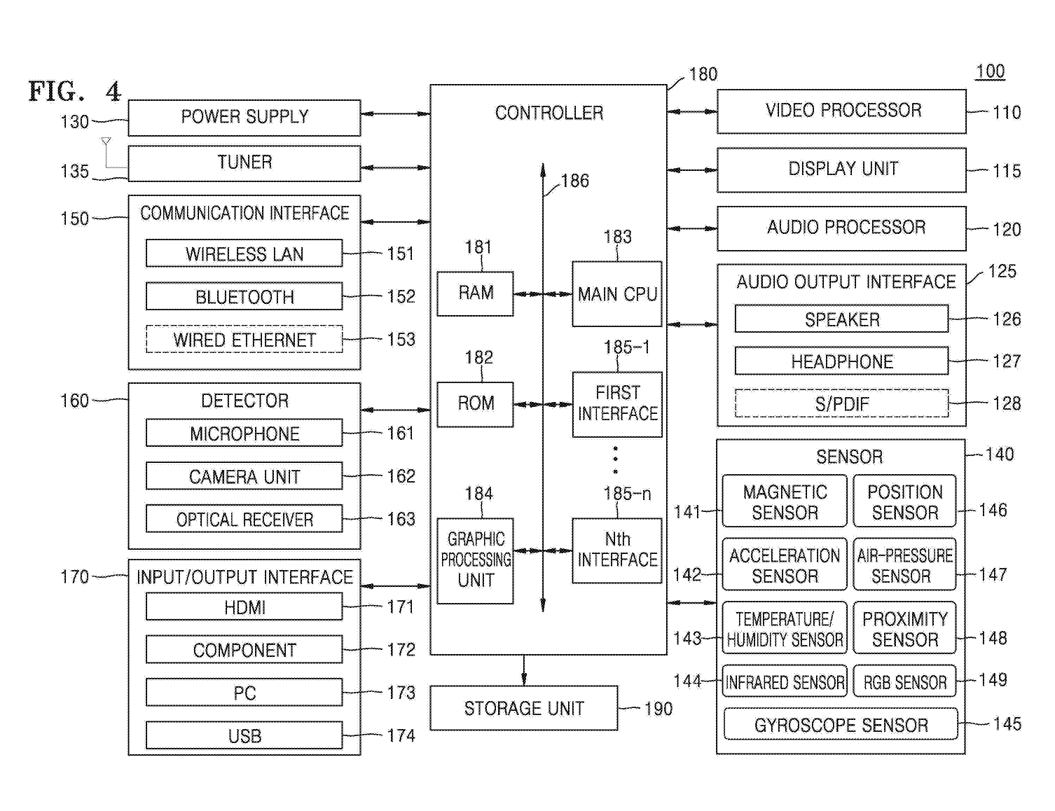

FIGS. 3 and 4 are block diagrams of the electronic device 100 according to an exemplary embodiment.

Referring to FIG. 3, the electronic device 100 may include the display 115 and the controller 180. However, not all components are necessary. The electronic device 100 may be embodied by more or less components than the components shown in FIG. 3.

For example, as shown in FIG. 4, the electronic device 100 may further include a video processor 110, an audio processor 120, an audio output interface 125, a power supply 130, the tuner 135, a sensor 140, a communication interface 150, a detector 160, an input/output interface 170, and a storage 190.

Hereinafter, the aforementioned components will be described.

The video processor 110 processes video data received by the electronic device 100. The video processor 110 may perform various image processing processes such as decoding, scaling, noise filtering, frame-rate conversion, resolution conversion, or the like, for the video data.

The display 115 may display, on a screen, a video included in a broadcast signal received via the tuner 135. Also, the display 115 may display content (e.g., a moving image) that is input by the communication interface 150 or the input/output interface 170. The display 115 may output an image stored in the storage 190 according to the control of the controller 180. Also, the display 115 may display a voice user interface (UI) (e.g., a voice instruction guide) that corresponds to voice recognition and performs a voice recognition task or a motion UI (e.g., a user motion guide for motion recognition) that corresponds to motion recognition and performs a motion recognition task.

The display 115 may display the broadcast content received via the tuner 135 according to the control of the controller 180.

Also, the display 115 may display information about the search result using the search query by using the external server.

Also, the display 115 may be divided into multiple portions. The broadcast content may be displayed on one among the portions, and the information about the search result may be displayed on another one among the portions.

The audio processor 120 may process audio data. The audio processor 120 may perform various processes, for example, decoding, amplification, noise filtering, or the like, for the audio data. The audio processor 120 may include audio processing modules to process audios corresponding to multiple pieces of content.

The audio output interface 125 outputs audios included in broadcast signals received via the tuner 135, according to the control of the controller 180. The audio output interface 125 may output an audio (e.g., a voice, a sound, etc.) that is input via the communication interface 150 or the input/output interface 170. Also, the audio output interface 125 may output an audio stored in the storage 190 according to the control of the controller 180. The audio output interface 125 may include at least one among a speaker 126, a headphone output terminal 127, and a Sony/Philips Digital Interface (S/PDIF) output terminal 128. The audio output interface 125 may include a combination of the speaker 126, the headphone output terminal 127, and the S/PDIF output terminal 128.

According to the control of the controller 180, the power supply 130 supplies power input from an external power source to the components within the electronic device 100, that is, the video processor 110, the audio processor 120, the audio output interface 125, the power supply 130, the tuner 135, the sensor 140, the communication interface 150, the detector 160, the input/output interface 170, and the storage 190. Also, the power supply 130 may supply power, which is output from one or more batteries located inside the electronic device 100, to the components within the electronic device 100, that is, the video processor 110, the audio processor 120, the audio output interface 125, the power supply 130, the tuner 135, the sensor 140, the communication interface 150, the detector 160, the input/output interface 170, and the storage 190, according to the control of the controller 180.

The tuner 135 may tune a frequency of a channel that the user wants to receive in the electronic device 100, via electronic components, through amplification, mixing, resonance, etc. of broadcast signals transmitted in a wired or wireless manner, and may select the tuned frequency. The broadcast signal may include an audio, a video, and additional information (e.g., an Electronic Program Guide (EPG), etc.).

The tuner 135 may receive a broadcast signal in a frequency band corresponding to a channel number (e.g., No. 506 of a cable channel, etc.) according to a user input (e.g., a control signal received from a control device, an up-down input in a channel, a channel input on an EPG screen, etc.).

The tuner 135 may receive a broadcast signal from various sources such as a terrestrial broadcast, a cable broadcast, a satellite broadcast, and an Internet broadcast. The tuner 135 may receive a broadcast signal from a source such as an analog broadcast, a digital broadcast, or the like. The broadcast signal received by the tuner 135 is decoded (e.g., audio decoding, video decoding, or additional information decoding) and thus is separated into an audio, a video, and/or additional information. The audio, the video, and/or the additional information that are separated may be stored in the storage 190 according to the control of the controller 180.

The electronic device 100 may include one or more tuners 135. The tuner 135 may be of an all-in-one type in which the tuner 135 is integrally formed with the electronic device 100 or may be a separate device (e.g., a set-top box) that is electrically connected to the electronic device 100 or to the input/output device 170.

The tuner 135 may receive the broadcast signal according to the control of the controller 180 and may output the received broadcast signal to the display 115.

The sensor 140 may detect a state of the electronic device 100 or a state around the electronic device 100 and may transmit information about the detected state to the controller 180. The sensor 140 may include at least one among a magnetic sensor 141, an acceleration sensor 142, a temperature/humidity sensor 143, an infrared sensor 144, a gyroscope sensor 145, a position sensor 146 (e.g., a global positioning system (GPS)), an air-pressure sensor 147, a proximity sensor 148, and a red-green-blue (RGB) (an illumination sensor) 149, but is not limited thereto. Functions of each sensor may be easily inferred from its name, and thus, detailed descriptions thereof will be omitted.

Also, the sensor 140 may include a sensor for detecting a touch input that is input by an input device and a sensor for detecting a user touch input. In this case, the sensor for detecting a user touch input may be included in a touch screen or a touch pad. Also, the sensor for detecting a touch input that is input by an input device may be located under a touch screen or a touch pad or may be included therein.

The communication interface 150 may connect the electronic device 100 to an external device (e.g., an audio device, etc.) according to the control of the controller 180. The controller 180 may receive/transmit content from/to the external device via the communication interface 150, download an application from the external device, or browse the Internet.

The communication interface 150 may include at least one among a wireless local area network (LAN) 151, Bluetooth 152, and wired Ethernet 153, depending on functions and a structure of the electronic device 100. The communication interface 150 may include a combination of the wireless LAN 151, the Bluetooth 152, and the wired Ethernet 153.

Also, the communication interface 150 may include a Bluetooth Low Energy (BLE) communication interface, a Near Field Communication interface, a WLAN (Wi-Fi) communication interface, a Zigbee communication interface, an infrared Data Association (IrDA) communication interface, a Wi-Fi Direct (WFD) communication interface, a ultra wideband (UWB) communication interface, an Ant+ communication interface, and the like, but is not limited thereto.

Also, the communication interface 150 may receive/transmit a wireless signal from/to at least one among a base station, an external terminal, and a server via a mobile network. The wireless signal may include various types of data according to a voice call signal, a video telephony call signal, or reception/transmission of a text/multimedia message.

Also, the communication interface 150 may include a broadcast receiver that receives a broadcast signal and/or information associated with broadcasts from the outside via a broadcast channel. The broadcast channel may include a satellite channel and a terrestrial broadcast channel.

Also, the communication interface 150 may receive a control signal of an external control device according to the control of the controller 180. The control signal may be of a Bluetooth type, a radio frequency (RF) signal type, or a Wi-Fi type.

The detector 160 detects a voice, an image, or an interaction of the user.

A microphone 161 receives voice signals via an utterance of the user. The microphone 161 may convert the received voice signals into electrical signals and output the electrical signals to the controller 180. The voice signals of the user may include voice signals corresponding to a menu or a function of the electronic device 100. A recognition range of the microphone 161 has to be less than or equal to 4 m from the microphone 161 to a location of the user and may differ according to a voice volume of the user and an environment around the user (e.g., a sound output from a speaker, ambient noise, etc.).

The microphone 161 may be formed integrally with the electronic device 100 or separately therefrom. The microphone 161 that is separately formed may be electrically connected to the electronic device 100 via the communication interface 150 or the input/output interface 170.

The microphone 161 may be or may not be included in the electronic device 100, depending on functions or structures of the electronic device 100.

A camera unit 162 may include a lens and an image sensor. The camera unit 162 may support an optical zoom function or a digital zoom function by using lenses and image processing. A recognition range of the camera unit 162 may vary with an angle of a camera and neighboring environmental conditions. When the camera unit 162 includes cameras, the camera unit 162 may receive a 3D static image or a 3D motion by using the cameras.

The camera unit 162 may be formed integrally with the electronic device 100 or separately therefrom. A separate device including the camera unit 162 that is separately formed may be electrically connected to the electronic device 100 via the communication interface 150 or the input/output interface 170.

The camera unit 162 may be or may not be included in the electronic device 100, depending on functions or structures of the electronic device 100.

An optical receiver 163 receives an optical signal (including a control signal) that is received from an external control device via an optical window of a bezel of the display 115. The optical receiver 163 may receive an optical signal corresponding to a user input (e.g., a touch, a press, a touch gesture, a voice, a motion, etc.) from the external control device. A control signal may be extracted from the received optical signal according to the control of the controller 180.

The input/output interface 170 receives a video (e.g., a moving image, etc.), an audio (e.g., a voice, a piece of music, etc.), additional information (e.g., an EPG, etc.) from the outside of the electronic device, according to the control of the controller 180. The input/output interface 170 may include one among a High-Definition Multimedia Interface (HDMI) port 171, a component jack 172, a PC port 173, and a universal serial bus (USB) port 174. The input/output interface 170 may include a combination of the HDMI port 171, the component jack 172, the PC port 173, and the USB port 174.

Structures and operations of the input/output interface 170 may vary according to embodiments.

The controller 180 controls overall operations of the electronic device 100 and signal flow between the components of the electronic device 100, that is, the video processor 110, the audio processor 120, the audio output interface 125, the power supply 130, the tuner 135, the sensor 140, the communication interface 150, the detector 160, the input/output interface 170, and the storage 190, and performs a data processing function. When there is a user input or a condition that is set and stored in advance is satisfied, the controller 180 may execute an operation system (OS) and various applications that are stored in the storage 190.

The controller 180 may store signals or data input from outside the electronic device 100 or may include random access memory (RAM) 181 used as a storage area corresponding to tasks performed in the electronic device 100, read only memory (ROM) 182 in which a control program for controlling the electronic device 100 is stored, and a processor 183.

The processor 183 may include a graphic processing unit (GPU) for processing graphics corresponding to a video. The processor 183 may be embodied as a system on chip (SoC) in which a core and the GPU are combined. The processor 183 may include a single core, a dual core, a triple core, a quad core, and a multiple core.

Also, the processor 183 may include multiple processors. For example, the processor 183 may be embodied as a main processor and a sub processor operating in a sleep mode.

The GPU 184 creates a screen via which various objects such as icons, images, and texts are shown by using a calculation unit and a rendering unit. The calculation unit calculates attribute values such as coordinates, where each object is located, shapes, sizes, and colors, by using user interactions detected by the detector 160, according to a layout of a screen. The rendering unit creates a screen having various layouts including objects, based on the attribute values calculated by the calculation unit. The screen created by the rendering unit is displayed within a display area of the display 115.

First to n^{th} interfaces 185-1 to 185-n are connected to the above-described components. One among the first to n^{th} interfaces 185-1 to 185-n may be a network interface connected to an external device via a network.

The RAM 181, the ROM 182, the processor 183, the GPU 184, and the first to n^{th} interfaces 185-1 to 185-n may be interconnected via an internal bus 186.

In the present specification, the term “controller” denotes a controller including the RAM 181, the ROM 182, and the processor 183.

The controller 180 of the electronic device 100 may extract at least one object by analyzing broadcast content received via the tuner 135.

Also, the controller 180 may extract the at least one object from an image, a sound effect, a subtitle, and additional information included in the broadcast content by analyzing at least one among a person, a product, and a situation.

Also, the controller 180 may analyze the broadcast content that is received at a point in time when a user selection input for analyzing the broadcast content is received.

Also, the controller 180 may extract at least one keyword that identifies the at least one object.

Also, the controller 180 may extract, as the at least one keyword, at least one among a name, an abbreviated name, a nickname, and a symbol that identify the at least one object.

Also, the controller 180 may select keywords for generating search queries from the at least one keyword.

Also, the controller 180 may send a request for information about keyword selection criteria including a use frequency to the external server via the communication interface 150 and may select the keywords for generating the search queries based on the information about the keyword selection criteria that is received from the external device.

Also, the controller 180 may select the keywords for generating the search queries based on user setting information.

Also, the controller 180 may generate a search query by combining the selected keywords in a preset order of arranging the keywords.

Also, the controller 180 may provide the user with information about search results using the search query.

Also, the controller 180 may transmit the generated search query to the external server and may receive the information about the search results using the search query from the external server, via the communication interface 150.

Also, the controller 180 may display the information about the search results on the display 115.

Also, the controller 180 may divide the display 115 into portions, display the broadcast content on one among the divided portions, and display the information about the search results on another one among the divided portions.

Also, the controller 180 may transmit the information about the search results to a pre-set display device and control the display device to display the information about the search results on a display thereof.

Also, when multiple search queries are generated, the controller 180 may determine one among the search queries according to a search result based on each search query and may provide information about a search result using the determined search query.

Structures and operations of the controller 180 may vary according to embodiments.

The storage 190 may store data, programs, or applications used to operate and control the electronic device 100 according to the control of the controller 180. The storage 190 may store input/output signals or data corresponding to operations of the video processor 110, the display 115, the audio processor 120, the audio output interface 125, the power supply 130, the tuner 135, the communication interface 150, the detector 160, and the input/output interface 170. The storage 190 may store a control program used to control the electronic device 100 and the controller 180, applications that are initially provided by a manufacturer or downloaded from the outside, a graphical user interface (GUI) associated with the applications, objects (e.g., image texts, icons, buttons, etc.) for providing the GUI, user information, documents, databases, or relevant data.

According to an exemplary embodiment, the term “storage” denotes a storage including the storage 190, the ROM 182 and the RAM 181 of the controller 180, or a memory card (e.g., a micro SD card, a USB memory, etc.) mounted on the electronic device 100. Also, the storage 190 may include a non-volatile memory, a volatile memory, a hard disk drive (HDD), or a solid state drive (SSD).

The storage 190 may include a broadcast reception module, a channel control module, a volume control module, a communication control module, a voice recognition module, a motion recognition module, an optical reception module, a display control module, an audio control module, an external input control module, a power control module, a power control module of an external device connected in a wireless manner (e.g., Bluetooth), a voice database (DB), or a motion DB. The modules and DB s included in the storage 190 may be embodied as software to perform a broadcast reception control function, a channel control function, a volume control function, a communication control function, a voice recognition function, a motion recognition function, an optical reception control function, a display control function, an audio control function, an external input control function, a power control function, or a power control function of an external device connected in a wireless manner (e.g., Bluetooth). The controller 180 may perform the aforementioned functions by using the software included in the storage 190.

Also, the electronic device 100 including the display 115 may be electrically connected to a separate external device (e.g., a set-top box) including a tuner. For example, the electronic device 100 may be embodied as an analog TV, a digital TV, a 3D TV, a smart TV, an LED TV, an OLED TV, a plasma TV, a monitor, or the like, but is not limited thereto.

The electronic device 100 of FIG. 4 may further include at least one component besides the components (e.g., the video processor 110, the audio processor 120, the audio output interface 125, the power supply 130, the tuner 135, the sensor 140, the communication interface 150, the detector 160, the input/output interface 170, and the storage 190), or at least one among the above components may not be included in the electronic device 100, according to performance of the electronic device 100. Also, locations of the components (e.g., the video processor 110, the audio processor 120, the audio output interface 125, the power supply 130, the tuner 135, the sensor 140, the communication interface 150, the detector 160, the input/output interface 170, and the storage 190) may change according to performance or a structure of the electronic device 100.

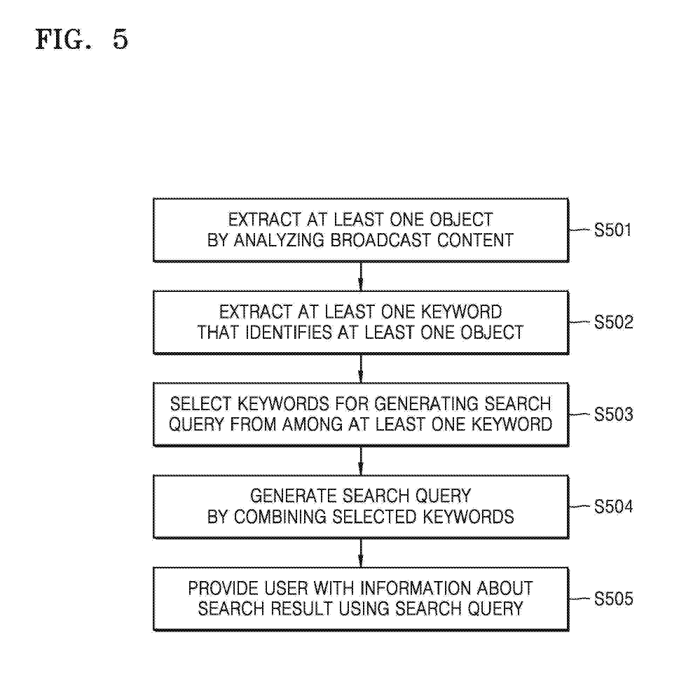

FIG. 5 is a flowchart of a method of providing information associated with broadcast content, according to an exemplary embodiment.

In operation S501 of FIG. 5, the controller 180 may extract at least one object by analyzing the broadcast content displayed on the display 115. The controller 180 may extract the at least one object from an image, a sound effect, a subtitle, and additional information included in the broadcast content by analyzing a character, a thing, and a situation.

According to an exemplary embodiment, an entity image may be analyzed based on the image included in the broadcast content, the sound effect included in the broadcast content may be analyzed by using automatic speech recognition (ASR) technology, or the subtitle included in the broadcast content may be analyzed by using optical character reader (OCR) technology.

The controller 180 may extract at least one object from the image, the sound effect, the subtitle, etc. by identifying an entity such as a person, a product, etc. or analyzing situation information. For example, when one character is identified from the image of the broadcast content, the identified character may be considered as one object. Also, when a name of a product, that is, ‘Galaxy Gear’, is analyzed from the sound effect of the broadcast content, the product may be considered as an object.

According to an exemplary embodiment, the controller 180 may analyze the broadcast content received at a point in time when a user selection input for analyzing the broadcast content is received. For example, when receiving a predetermined input (e.g., an input signal from a button of a TV remote control), the electronic device 100 may extract an object by analyzing a broadcast signal that is received at a point in time when the input signal is received.

In operation S502 of FIG. 5, the controller 180 may extract at least one keyword that identifies the object.

According to an exemplary embodiment, the controller 180 may extract at least one among a name, an abbreviated name, a nickname, and a symbol that identify the object, as the keyword.

For example, when the object extracted in operation S501 is a person, the controller 180 may extract, as keywords, a real name of the person, a character's name in a movie in which the person stars, and the like. Also, when the object extracted in operation S501 is a name of a product, the controller 180 may extract, as keywords, a name of the product (e.g., a smart watch), a proper noun (e.g., Galaxy Gear), an abbreviated name (e.g., Gear), etc.

In operation S503 of FIG. 3, the controller 180 may select keywords for generating a search query from the at least one keyword.

The controller 180 may send, to the external server, a request for information about keyword selection criteria including a use frequency. The controller 180 may select keywords for generating a search query, based on the information about the keyword selection criteria that is received from the external server.

The keyword selection criteria may be standards for selecting keywords that are appropriate to generate a search query from keywords when multiple keywords are extracted from each object in operation S502.

According to an exemplary embodiment, the controller 180 may select, as keywords for generating a search query, words having the highest use frequency from the keywords that identify the object. For example, the keyword selection criteria may include information about a use frequency of a word used in SNS posts, news articles, or the like.

Also, the controller 180 may select the keywords for generating the search query based on user setting information.

The controller 180 may provide keyword selection criteria and set keyword selection criteria regarding the keywords selected by the user. The keyword selection criteria may be set or changed by a user input.

For example, when a product's name and a proper noun are extracted as words that identify one object, the controller 180 may set in such a manner that the proper noun is selected prior to the product's name as a keyword for generating a search query, according to a user selection input.

In operation S504, the controller 180 may generate a search query by combining the selected keywords.

The controller 180 may generate the search query by combining the selected keywords in a preset order of arranging the keywords.

According to an exemplary embodiment, the order of arranging the keywords may denote search rules. For example, keywords may be combined in a stated order from a person's name, a food's name, and to a predicate. Also, keywords may be combined in an order from words having a high use frequency to words having a low use frequency in SNS posts, news articles, etc.

In operation S505, the controller 180 may provide the user with information about a search result using the search query.

The controller 180 may transmit the generated search query to the external server and may receive the information about the search result using the search query from the external server via the communication interface 150. Also, the external server may display the information about the search result on the display 115.

According to an exemplary embodiment, the controller 180 may divide the display 115 into multiple portions, display the broadcast content on one among the portions, and display the information about the search result on another one among the portions.

As another example, the controller 180 may transmit the information about the search result to a preset display device and may control the display device to display the information about the search result on a display thereof. For example, the user who watches TV may check information associated with broadcast content that is being broadcasted on the TV, on a smart phone of the user.

When multiple search queries are generated, the controller 180 may determine one among the search queries according to a search result based on each search query and may provide information about the search result using the determined search query.

According to an exemplary embodiment, the controller 180 may generate search query candidates in operation S504. The controller 180 may determine a search query having a greatest amount of information with respect to a search result among the search results based on the search queries. The controller 180 may display the information about the search result using the determined search query on the display 115 or may transmit the information about the search result to another display device.

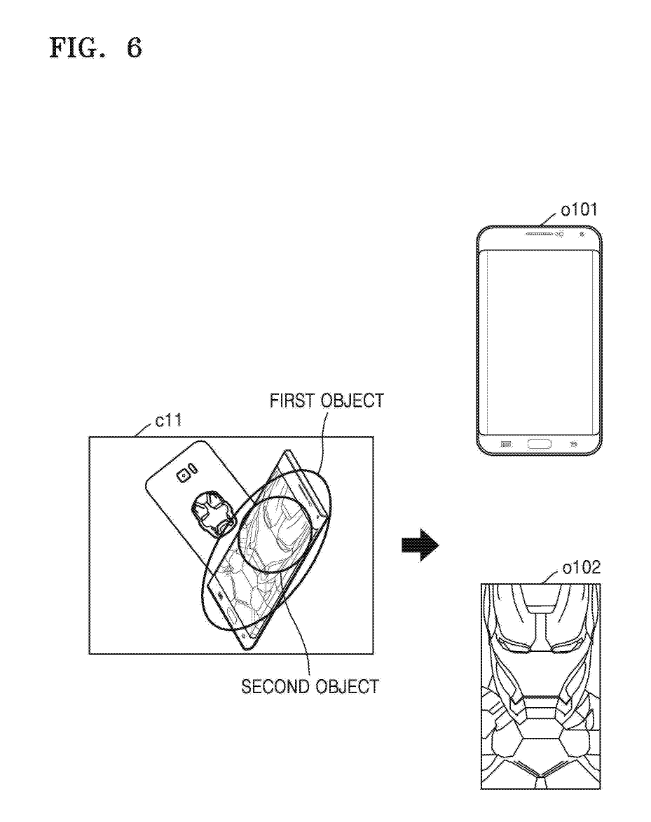

FIG. 6 is a diagram of an example of analyzing broadcast content according to an exemplary embodiment.

As shown in FIG. 6, according to an exemplary embodiment, the controller 180 may extract a first object o101 (e.g., a smart phone) and a second object o102 (e.g., a character image) from an image c11 included in the broadcast content through object recognition.

However, the example of FIG. 6 is not limited thereto.

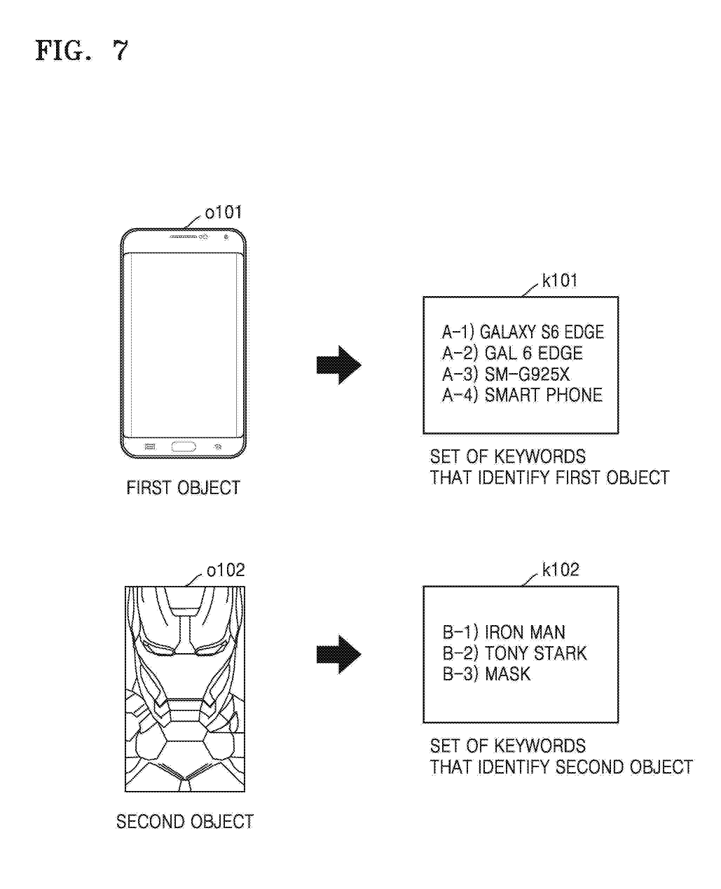

FIG. 7 is a diagram of an example of extracting a keyword that identifies an object, according to an exemplary embodiment.

As shown in FIG. 7, according to an exemplary embodiment, the controller 180 may extract keywords k101, for example, A-1) Galaxy S6 Edge, A-2) Gal 6 Edge, A-3) SM-G925X, and A-4) a smart phone, which identify the first object o101 (e.g., a smart phone).

Also, the controller 180 may extract keywords k102, for example, B-1) Iron Man, B-2) Tony Stark, and B-3) a mask, which identify the second object o102 (e.g., a character image).

However, the example of FIG. 7 is not limited thereto.

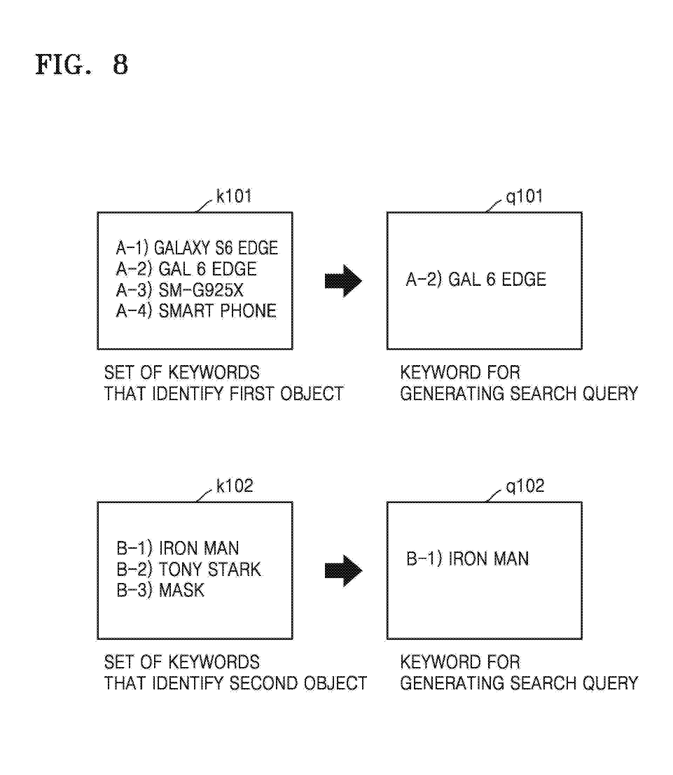

FIG. 8 is a diagram of an example of selecting a keyword for generating a search query, according to an exemplary embodiment.

As shown in FIG. 8, according to an exemplary embodiment, the controller 180 may select one keyword q101, that is, A-2) Gal 6 Edge, as a keyword for generating a search query, from the keywords k101 (e.g., A-1) Galaxy S6 Edge, A-2) Gal 6 Edge, A-3) SM-G925X, and A-4) a smart phone) which identify the first object o101 (e.g., a smart phone).

Also, the controller 180 may select one keyword q102, that is, B-1) Iron Man, as a keyword for generating a search query, from the keywords k102 (e.g., B-1) Iron Man, B-2) Tony Stark, and B-3) a mask) which identify the second object o102 (e.g., the character image).

However, the example of FIG. 8 is not limited thereto.

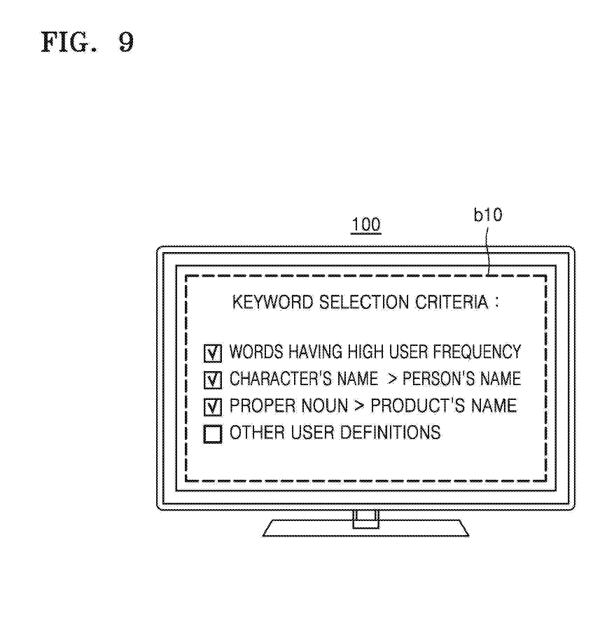

FIG. 9 is a diagram of an example of information about keyword selection criteria according to an exemplary embodiment.

The keyword selection criteria described with reference to FIG. 8 may be, for example, a word having a high use frequency, a character's name having a priority over a person's name, a proper noun having a priority over a product's name, other criteria defined by the user, or the like.

According to an exemplary embodiment, the electronic device 100 may provide the display 115 with an interface screen b10 such that the user may select at least one from the keyword selection criteria.

For example, the interface screen b10 that provides the keyword selection criteria may be provided via a menu such as an environment setting menu of the electronic device 100.

Also, the interface screen b10 that provides the keyword selection criteria may be provided as a pop-up window, etc. on a screen of the broadcast content after a user selection input for analyzing the broadcast content displayed on the display 115 is received.

The example of FIG. 9 is not limited thereto.

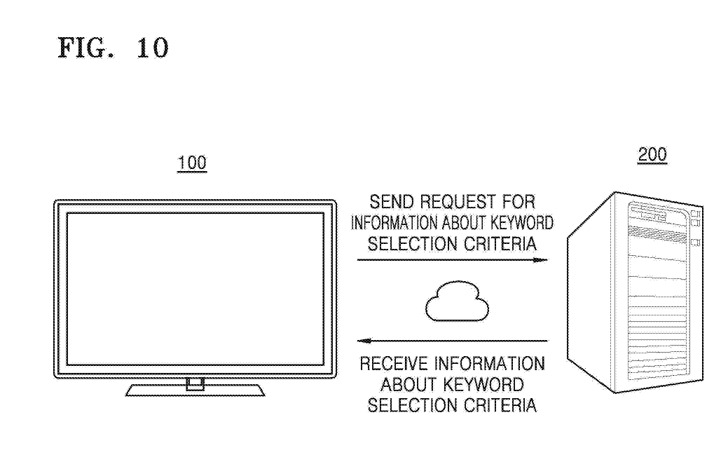

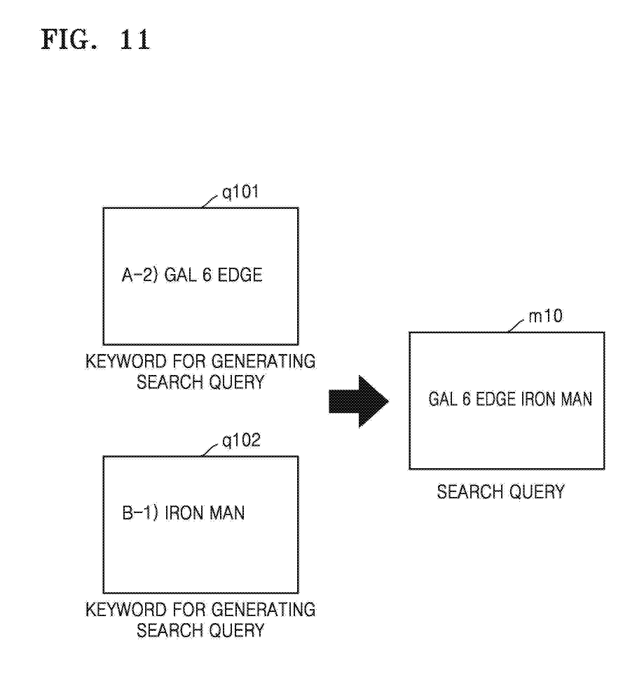

FIG. 10 is a diagram of an example of obtaining information about keyword selection criteria according to an exemplary embodiment.

According to an exemplary embodiment, the controller 180 of the electronic device 100 may send a request for the information about the keyword selection criteria including a use frequency to an external server 300 via the communication interface 150. The controller 180 may receive the information about the keyword selection criteria from the external server 300 via the communication interface 150.

For example, the keyword selection criteria may be information about a use frequency of a word used in SNS posts, news articles, etc. The controller 180 may receive, from the external server 300, information about a word that is most frequently used in the SNS posts, etc.

According to an exemplary embodiment, the controller 180 may select a keyword for generating a search query based on the information about the keyword selection criteria that is received from the external server 300.

FIG. 11 is a diagram of an example of generating a search query according to an exemplary embodiment.

According to an exemplary embodiment, the controller 180 of the electronic device 100 may generate a search query by combining the selected keywords (refer to FIG. 8) based on a preset order of arranging keywords.

As shown in FIG. 11, for example, the controller 180 may generate a search query, that is, ‘Gal 6 Edge Iron Man’ m10, by combining the keywords, that is, ‘Gal 6 Edge’ q101 and ‘Iron Man’ q102, which are selected to generate the search query (refer to FIG. 8).

The example of FIG. 11 is not limited thereto.

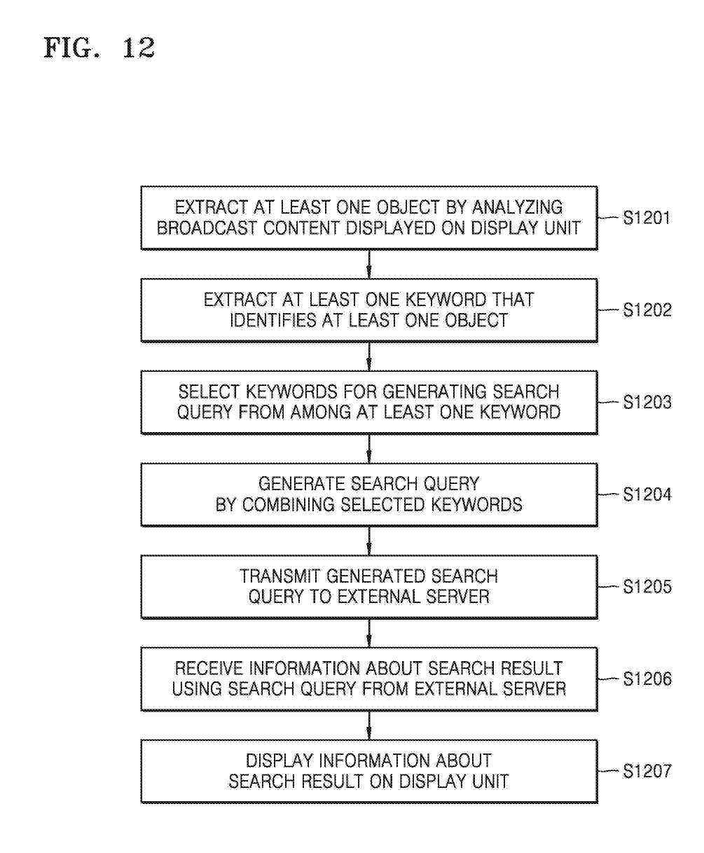

FIG. 12 is a diagram of an example of providing, via an external server, information about a search result using a search query, according to an exemplary embodiment.

In operation S1201, the controller 180 of the electronic device 100 may extract at least one object by analyzing broadcast content displayed on the display 115. In operation S1202, the controller 180 of the electronic device 100 may extract at least one keyword that identifies the at least one object extracted in operation S1201. In operation S1203, the controller 180 of the electronic device 100 may select keywords for generating a search query from the at least one keyword extracted in operation S1202. In operation S1204, the controller 180 of the electronic device 100 may generate a search query by combining the keywords that are selected in operation S1203.

Because descriptions of operations S1201 to S1204 are similar to those of operations S501 to S504 of FIG. 5, detailed descriptions of operations S1201 to S1204 will be omitted.

In operation S1205, the controller 180 of the electronic device 100 may transmit the search query, which is generated in operation S1204, to an external server. In operation S1206, the controller 180 of the electronic device 100 may receive information about a search result using the search query from the external device.

According to an exemplary embodiment, the controller 180 may transmit the search query to a preset search server. The external server to which the search query is to be transmitted may be, for example, a server of a web portal, but is not limited thereto.

According to an exemplary embodiment, the controller 180 may set the search server, to which the search query is to be transmitted, to be a default when the electronic device 100 is manufactured. Also, the controller 180 may set or change the search server, depending on a user input.

In operation S1207 of FIG. 12, the controller 180 of the electronic device 100 may display the information about the search result on the display 115.

According to an exemplary embodiment, the controller 180 may display the information about the search result to overlap part of the broadcast content that has been displayed on the display 115. Also, the controller 180 may divide the display 115 into portions and may display the information about the search result on one among the portions.

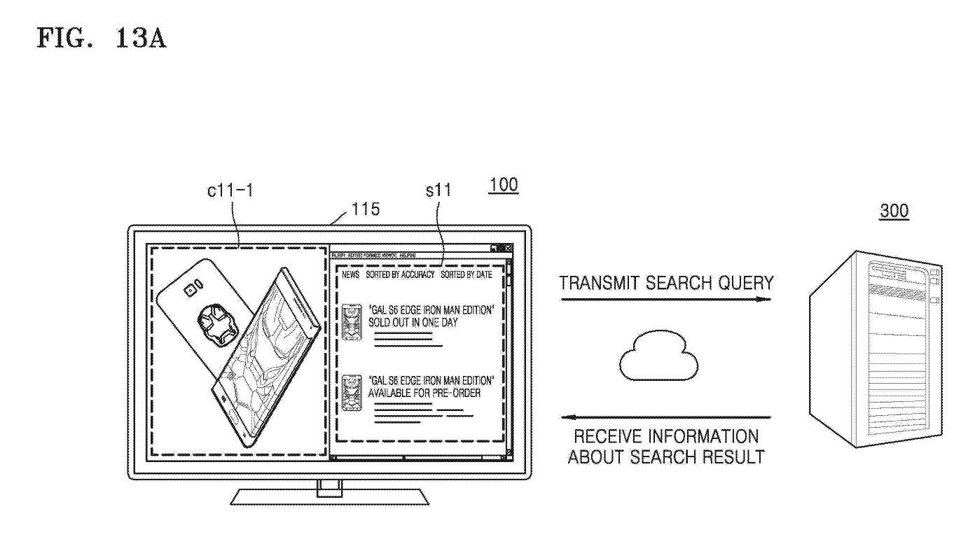

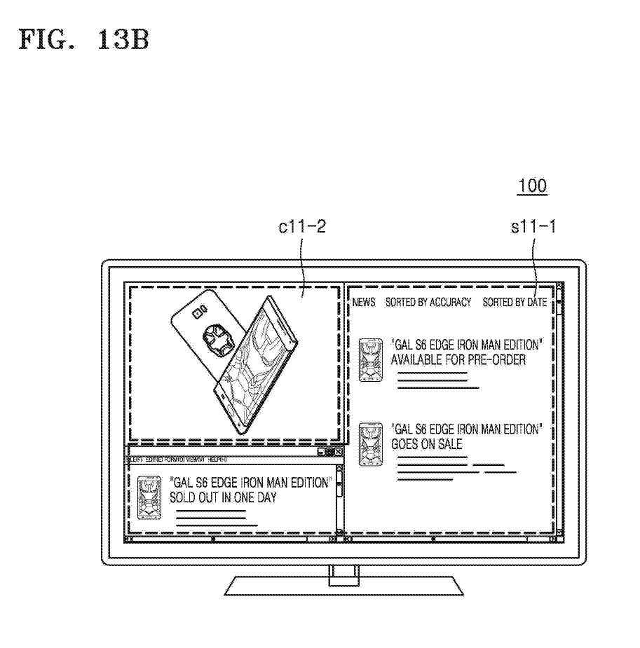

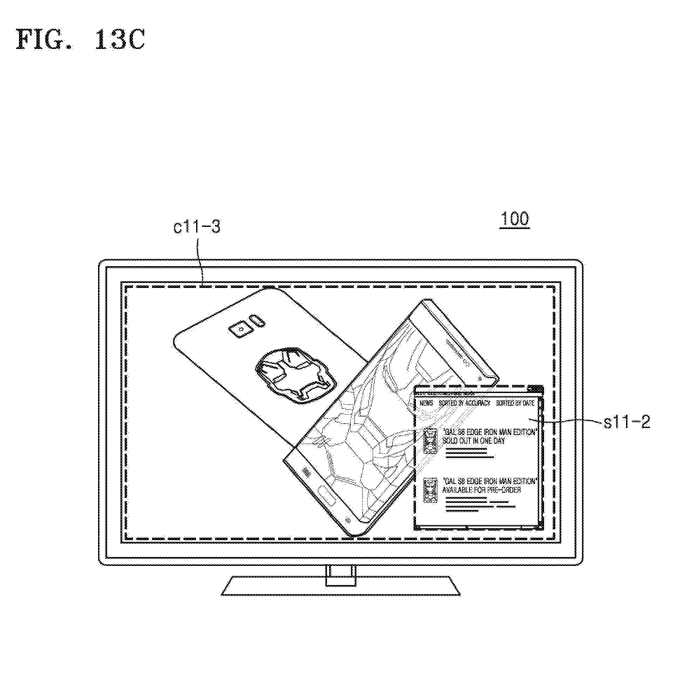

FIGS. 13A, 13B, and 13C are diagrams of an example of providing, via a server, information s11 about a search result using a search query according to an exemplary embodiment.

As shown in FIG. 13A, according to an exemplary embodiment, the controller 180 may transmit the search query to the external server 300 that provides a search service and may receive the information s11 about the search result from the external server 300, via the communication interface 150.

According to an exemplary embodiment, the controller 180 may divide the display 115 into portions, display broadcast content c11-1 on one among the portions, and display the information s11 that is received from the external server 300 on another one among the portions.

For example, the controller 180 may display the broadcast content c11-1 that is being displayed on a portion of the display 115 and may display the information s11 (e.g., a news article including the search query) about the search result using the search query on another portion of the display 115.

Referring to FIG. 13A, the display 115 is divided into left and right portions. As a horizontal resolution of a screen on which the broadcast content c11-1 is being displayed decreases (refer to FIG. 1A), the broadcast content c11-1 is displayed on the left portion, and the information s11 may be displayed on the right portion. However, exemplary embodiments are not limited thereto.

As another example, referring to FIG. 13B, broadcast content c11-2 having decreased vertical and horizontal resolutions may be displayed on a region of the display 115 (refer to FIG. 1A), and the information s11 about the search result using the search query may be displayed on other regions of the display 115.

As another example, the display 115 is divided into top and bottom regions. The broadcast content that has been displayed and has a decreased vertical resolution (refer to FIG. 1A) is displayed on the top region of the display 115, and the information about the search result may be displayed on the bottom region of the display 115. However, the present disclosure is not limited thereto.

Also, referring to FIG. 13C, in a state in which the broadcast content c11-3 has been displayed (refer to FIG. 1A), information s11-2 about the search result may overlap the broadcast content.

As shown in FIG. 13C, the information s11-2 about the search result may translucently overlap the broadcast content c11-3.

As another example, a region where the information s11-2 about the search result is displayed may be opaque in such a manner that part of the broadcast content c11-3 is covered by the opaque region.

According to an exemplary embodiment, the controller 180 may control the transparency of a region where information about a search result is displayed. The electronic device 100 may set the transparency of the region, where the information about the search result is displayed, to be a default or may set or change the transparency of the region according to a user input.

When receiving a preset user input (e.g., an input signal from a button of a TV remote control), the electronic device 100 may display the information about the search result on the display 115 by analyzing the broadcast content. However, the present disclosure is not limited thereto.

For example, when the user wants to obtain information associated with broadcast content being broadcasted while watching TV, the user presses a button of a TV remote control and thus may easily obtain the information associated with the broadcast content.

As another example, when receiving a preset user input (e.g., an input signal from a button of a TV remote control), the electronic device 100 may store information about a search result in the storage 190 by analyzing the broadcast content, or when receiving another user input for displaying a search result, the electronic device 100 may display the information about the search result on the display 115.

For example, when the user wants to obtain information associated with broadcast content being broadcasted while watching TV, the user may press a button of a TV remote control to allow the information associated with the broadcast content to be searched for first and may check information about a search result at a point in time when the user wants to check the information about the search result.

After a period of time passes after the information s11, s11-1, and s11-2 about the search results is displayed, the electronic device 100 may control the information s11, s11-1, and s11-2 to disappear and may display the broadcast content, which has been displayed, on the entire display 115. However, the present disclosure is not limited thereto.

As another example, when the electronic device 100 receives a preset user input after displaying the information s11, s11-1, and s11-2 about the search results on the display 115, the electronic device 100 may control the information s11, s11-1, and s11-2 to disappear and may display the broadcast content, which has been displayed, on the entire display 115.

However, the examples of the FIGS. 13A to 13C are not limited thereto.

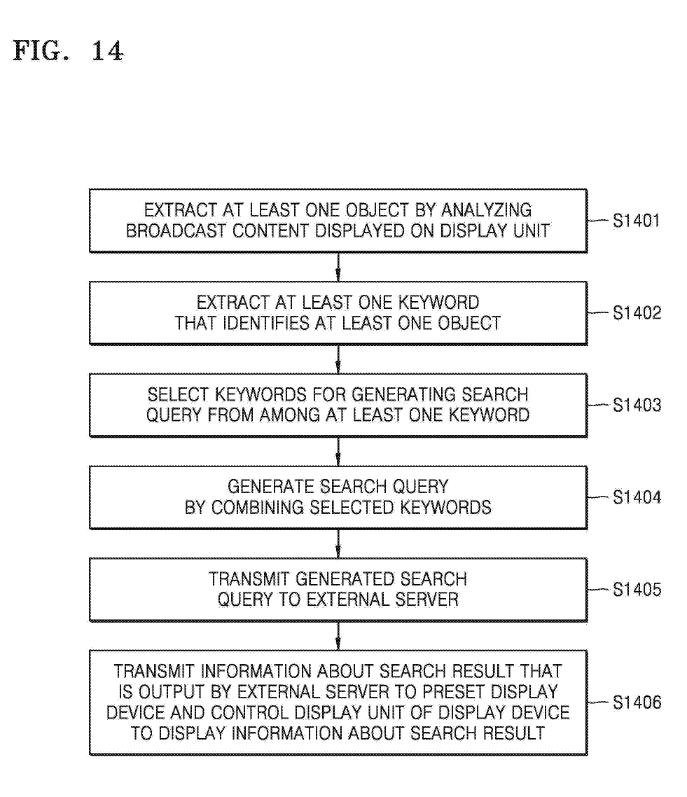

FIG. 14 is a flowchart of an example of displaying information about a search result on a display device, according to an exemplary embodiment.

In operation S1401 of FIG. 14, according to an exemplary embodiment, the controller 180 of the electronic device 100 may extract at least one object by analyzing broadcast content displayed on the display 115. In operation S1402, the controller 180 of the electronic device 100 may extract at least one keyword that identifies the at least one object extracted in operation S1401. In operation S1403, the controller 180 of the electronic device 100 may select keywords for generating a search query from the at least one keyword extracted in operation S1402. In operation S1404, the controller 180 of the electronic device 100 may generate a search query by combining the keywords selected in operation S1403.

Because descriptions of operations S1401 to S1404 are similar to those of operations S501 to S504 of FIG. 5, detailed descriptions of operations S1401 to S1404 will be omitted.

In operation S1405 of FIG. 14, the controller 180 of the electronic device 100 may transmit the generated search query to an external server. Because descriptions of operation S1405 are similar to those of operation S1205 of FIG. 12, detailed descriptions of operation S1405 will be omitted.

In operation S1406 of FIG. 14, the controller 180 of the electronic device 100 may transmit the information about the search result to a preset display device to the external server and may control the preset display device to display the information about the search result on a display thereof.

According to an exemplary embodiment, the electronic device 100 may search for a device that may be connected via Bluetooth among devices of the user and may transmit the information about the search result to the device that is connected via Bluetooth.

As another example, the electronic device 100 may set, in advance, another display device for receiving the information about the search result using the search query and may request the external server to transmit the information about the search result to the display device.

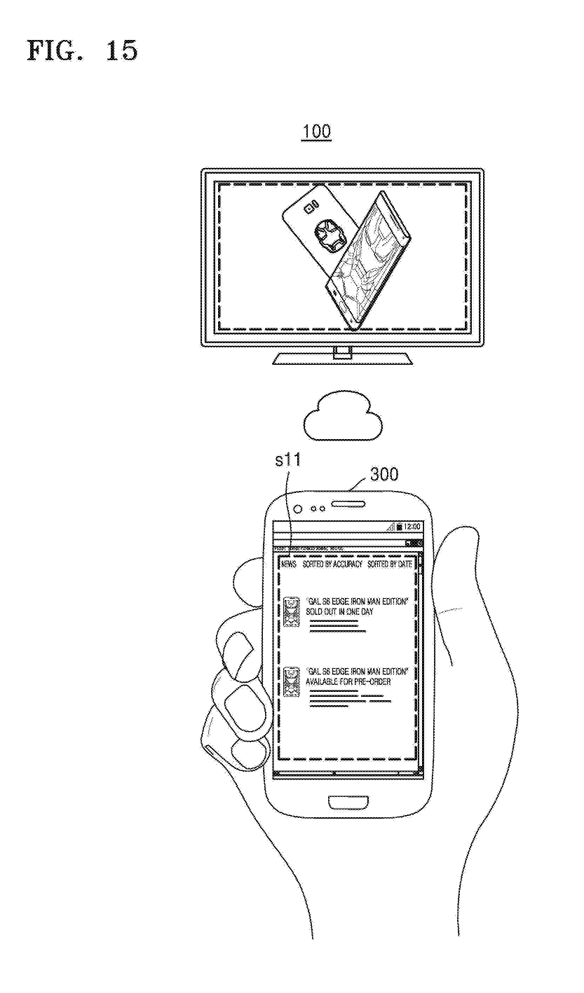

FIG. 15 is a diagram of an example of displaying information about a search result on a display device 300, according to an exemplary embodiment.

According to an exemplary embodiment, the controller 180 of the electronic device 100 may transmit information s11 about a search result using a search query to the display device 300 and may control the display device 300 to display the information s11 about the search result on a display thereof.

As shown in FIG. 15, for example, a user who watches TV may check, on a smart phone 300, news articles associated with broadcast content that is being broadcasted on the TV.

The above-described embodiments are examples, and the present disclosure is not limited by those embodiments. Also, orders in which operations are performed are not limited to the orders shown in the flowcharts of FIGS. 5, 12, and 14. According to embodiments, some operations can be omitted or added and also may be performed in an order opposite to the described order.

In addition, the exemplary embodiments may also be implemented through computer-readable code and/or instructions on a medium, e.g., a computer-readable medium, to control at least one processing element to implement any above-described embodiments. The medium may correspond to any medium or media that may serve as a storage and/or perform transmission of the computer-readable code.

The computer-readable code may be recorded and/or transferred on a medium in a variety of ways, and examples of the medium include recording media, such as magnetic storage media (e.g., ROM, floppy disks, hard disks, etc.) and optical recording media (e.g., compact disc read only memories (CD-ROMs) or digital versatile discs (DVDs)), and transmission media such as Internet transmission media. Thus, the medium may have a structure suitable for storing or carrying a signal or information, such as a device carrying a bitstream according to one or more exemplary embodiments. The medium may also be on a distributed network, so that the computer-readable code is stored and/or transferred on the medium and executed in a distributed fashion. Furthermore, the processing element may include a processor or a computer processor, and the processing element may be distributed and/or included in a single device.

The foregoing exemplary embodiments are examples and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. An electronic device for providing information associated with broadcast content, the electronic device comprising:
a tuner configured to receive the broadcast content; and
a controller configured to:
extract an object from the broadcast content;
determine one or more keywords identifying the object;
select keywords for generating a search query from the one or more keywords;
combine the selected keywords to generate the search query; and
provide a user with information of a search result using the search query.

2. The electronic device of claim 1, wherein the controller is further configured to extract the object from at least one among an image, a sound effect, a subtitle, and additional information comprised in the broadcast content by analyzing at least one among a person, a thing, and a situation comprised in the broadcast content.

3. The electronic device of claim 1, wherein the controller is further configured to determine, as the one or more keywords, at least one among a name, an abbreviated name, a nickname, and a symbol identifying the object.

4. The electronic device of claim 1, further comprising a communication interface,
wherein the controller is further configured to:
control the communication interface to transmit, to an external server, a request for information of keyword selection criteria comprising a use frequency; and
select the keywords for generating the search query from the one or more keywords, based on the information of the keyword selection criteria, the information being received from the external server.

5. The electronic device of claim 1, wherein the controller is further configured to select the keywords for generating the search query from the one or more keywords, based on user setting information.

6. The electronic device of claim 1, wherein the controller is further configured to combine the selected keywords in an order of arranging the keywords, to generate the search query.

7. The electronic device of claim 1, further comprising a communication interface,
wherein the controller is further configured to:
control the communication interface to transmit the search query to the external server; and
receive, from the external server via the communication interface, the information of the search result using the search query.

8. The electronic device of claim 1, further comprising a display,
wherein the controller is further configured to control the display to display the information of the search result.

9. The electronic device of claim 1, further comprising a display,
wherein the controller is further configured to:
divide the display into portions;
control the display to display the broadcast content on one among the portions; and
control the display to display the information of the search result on another one among the portions.

10. The electronic device of claim 1, wherein the controller is further configured to:
transmit the information of the search result to a preset display device; and
control the preset display device to display the information of the search result.

11. The electronic device of claim 1, wherein the controller is further configured to:
in response to search queries being generated, determine a search query among the search queries according to a search result based on each of the search queries; and
provide the user with information of a search result using the determined search query.

12. The electronic device of claim 1, wherein the controller is further configured to analyze the broadcast content received at a point in time, in response to a user selection input for analyzing the broadcast content.

13. A method of providing information associated with broadcast content, the method comprising:
receiving, by a tuner, the broadcast content;
extracting an object from the broadcast content;
determining one or more keywords identifying the object;
selecting keywords for generating a search query from the one or more keywords;
combining the selected keywords to generate the search query; and
providing a user with information of a search result using the search query.

14. The method of claim 13, wherein the extracting comprises extracting the object from at least one among an image, a sound effect, a subtitle, and additional information comprised in the broadcast content by analyzing at least one among a person, a thing, and a situation comprised in the broadcast content.

15. The method of claim 13, wherein the determining comprises determining, as the one or more keywords, at least one among a name, an abbreviated name, a nickname, and a symbol identifying the object.

16. The method of claim 13, wherein the selecting comprises:
transmitting, to an external server, a request for information of keyword selection criteria comprising a use frequency; and
selecting the keywords for generating the search query from the one or more keywords, based on the information of the keyword selection criteria, the information being received from the external server.

17. The method of claim 13, wherein the providing comprises:
dividing a display into portions;
displaying the broadcast content on one among the portions; and
displaying the information of the search result on another one among the portions.

18. The method of claim 13, wherein the providing comprises:
transmitting the information of the search result to a preset display device; and
controlling the preset display device to display the information of the search result.

19. The method of claim 13, wherein the providing comprises:
in response to search queries being generated, determining a search query among the search queries according to a search result based on each of the search queries; and
providing the user with information of a search result using the determined search query.

20. A non-transitory computer-readable recording medium having recorded thereon a program for executing the method according to claim 13.
